(19) United States
(12) Patent Application Publication
(10) Pub. No.: US 2012/0297832 A1
(43) Pub. Date: Nov. 29, 2012

(54) SILICON VACUUM MELTING METHOD

(76) Inventor: Kyojiro KANEKO, Ibaraki-shi (JP)

(21) Appl. No.: 13/567,234

(22) Filed: Aug. 6, 2012

Related U.S. Application Data
(63) Continuation of application No. PCT/JP2010/070428, filed on Nov. 17, 2010.

(30) Foreign Application Priority Data
Feb. 9, 2010 (JP) PCT/JP2010/051838

(51) Int. Cl. C01B 33/037

(52) U.S. Cl. 65/83

(57) ABSTRACT

A device provided with a furnace vessel 100, a water-cooled copper crucible 200 provided inside the furnace vessel 100, and a support rod 300 supporting a silicon electrode S is used. After disposing the silicon electrode S in the water-cooled cooled crucible 200 at predetermined intervals, the furnace vessel 100 is put into a vacuum state, and by applying voltage to the silicon electrode S and the water-cooled copper crucible 200, a current passes through and melts the silicon electrode S. While maintaining the top of the melted silicon S′ in a melted state, the melted silicon S′ is solidified sequentially from the bottom in the cooled water-cooled copper crucible 200.

### TECHNICAL FIELD

The present invention relates to a silicon vacuum melting method for melting and refining silicon material mainly for use in solar batteries.

### BACKGROUND ART

Solar batteries have been popularized as one of methods for improving grovel-scale environmental issues. Most manufactured solar batteries are made using silicon crystals from the view point of variety of resources and high photoelectric conversion efficiency, and technology for producing silicon material for use in solar batteries at less cost is desired.

In conventional technologies, in cases where 6N (99.9999%) or higher silicon material for solar batteries is produced from metallic silicon (about 99% in purity) by means of a metallurgic melting and refining method, as a method for eliminating or removing highly volatile impurity elements (e.g., phosphorous, calcium), it is proposed to dissipate impurities into a vapor phase by a vacuum melting refining method.

For example, Japanese Unexamined Laid-open Patent Application Publication No. H9-48606 (Japanese Patent Application No. H7-194482) discloses a method in which silicon is electron-beam melted in a water-cooled copper container under reduced pressure. Japanese Unexamined Laid-open Patent Application Publication No. 2006-232658 (Japanese Patent Application No. 2006-10293) discloses a method in which silicone is molten in a graphite crucible under reduced pressure by means of induction melting or increased temperature by a resistance heating element. In these methods, they describe elimination of volatile impurity elements (especially, elimination of phosphorous).

### DISCLOSURE OF THE INVENTION

### Problems to be Solved by the Invention

In the aforementioned conventional technologies, however, there are problems in productivity and economic efficiency. In detail, in the electron beam melting method, the method required expensive large facility cost and melting electrical cost with respect to the amount of production, while in the melting method in which melting is performed in a graphite crucible by means of induction melting or a resistance heating element, it was required long hours of refining processing and an expensive and high quality graphite crucible as consumable material.

The present invention was made in view of the aforementioned problems, and aims to provide a silicon vacuum melting method capable of producing silicon material for use in solar batteries at low cost with a simple structure.

### Means for Solving the Problems

According to one aspect of the present invention, in order to achieve the aforementioned objects, a silicon vacuum melting method includes the steps of:

preparing a device provided with a furnace vessel, a conductive crucible arranged in the furnace vessel, and a support rod arranged to support a silicon mass;

arranging the silicon mass in the crucible using the support rod with a gap between the silicon mass and the crucible;

vacuuming the furnace vessel and applying a voltage between the silicon mass and the conductive crucible to pass a current through the silicon mass as an electrode to thereby melt the silicon mass to obtain molten silicon; and

solidifying the molten silicon sequentially from a bottom portion of the molten alloy by cooling the crucible while maintaining a top portion of the molten silicon in a molten state.

With this method, volatile impurities in the silicon mass can be dissipated into a vapor phase and refined. Further, since the molten silicon is solidified sequentially from a bottom portion of the molten alloy by cooling the crucible while maintaining a top portion of the molten silicon in a molten state, a solidification segregation effect of impurities in the silicon mass can be obtained simultaneously. Therefore, silicon material for use in solar batteries can be produced at low cost with a simple structure.

In the method, it is preferable that a gap ratio defined by a ratio of a cross-sectional area of a gap between the crucible and the silicon mass to a cross-sectional area of the crucible is set so as to fall within a range of 0.4 to 0.6. With this, evaporative removal or elimination of impurities can be effectively executed and productivity can be further increased.

In addition, it is also preferable to use a silicon mass formed into a cross-section area which gradually decreases toward a tip end portion thereof and gradually increase an amount of current passing through the silicon mass to raise a temperature of the silicon mass. With this, silicon brittle fracture due to rapid temperature increase can be prevented.

Furthermore, it is also preferable to use a vapor deposition board or plate movable up-and-down and having a configuration covering an inner wall surface of the conductive crucible. With this, by moving the vapor deposition board upward so as not to come into contact with the molten silicon surface which raises in accordance with progress of melting of the silicon mass, it can be prevented impurities removed or eliminated by evaporation from adhering to an inner wall of the conductive crucible, which prevents impurities from being re-mixed into the molten silicon.

### Effects of the Invention

According to the present invention, volatile elements of the silicon mass can be dissipated or evaporated into a vapor phase and refined. Also, since the molten silicon is solidified sequentially from the bottom portion of the crucible by cooling the crucible while maintaining the top portion of the molten silicon in a molten state, solidification segregation effect of impurities in the silicon can be obtained simultaneously.

Also, since the device structure merely requires a crucible for accommodating molten silicon a spatial structure having a diameter nearly equal to a diameter of the crucible for vacuum discharging the crucible, the device structure for vacuum melting and solidification can be simple and miniaturized.

Furthermore, in the present invention, since a direct heating method in which an electrical current is passed through silicon is used, the energy efficiency for silicon melting is high, the melting speed is high, and therefore there are more advantages in terms of economic efficiency.

### BRIEF DESCRIPTION OF DRAWINGS

FIG. 1 is a schematic structural view of a device according to an embodiment of the present invention.

FIG. 2 is an enlarged view showing a main section of the device.

FIG. 3 is a cross-sectional view of the device taken along the line III-III in FIG. 2.

FIG. 4 is an enlarged view showing a main section of a device according to another embodiment of the present invention.

FIG. 5 is a schematic view showing a structure of a device according to still another embodiment of the present invention.

### BRIEF DESCRIPTION OF THE REFERENCE NUMERALS

1 . . . device
100 . . . furnace vessel
200 . . . water-cooled copper crucible
300 . . . support rod
400 . . . electrode feeding mechanism
500 . . . vapor deposition board
S . . . silicon electrode
S′ . . . molten silicon

### BEST MODE FOR CARRYING OUT THE INVENTION

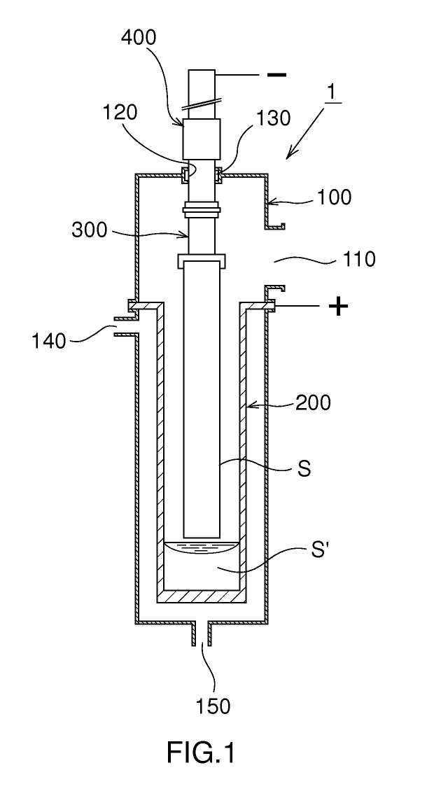

Next, an embodiment of the present invention will be explained with reference to FIGS. 1 to 3.

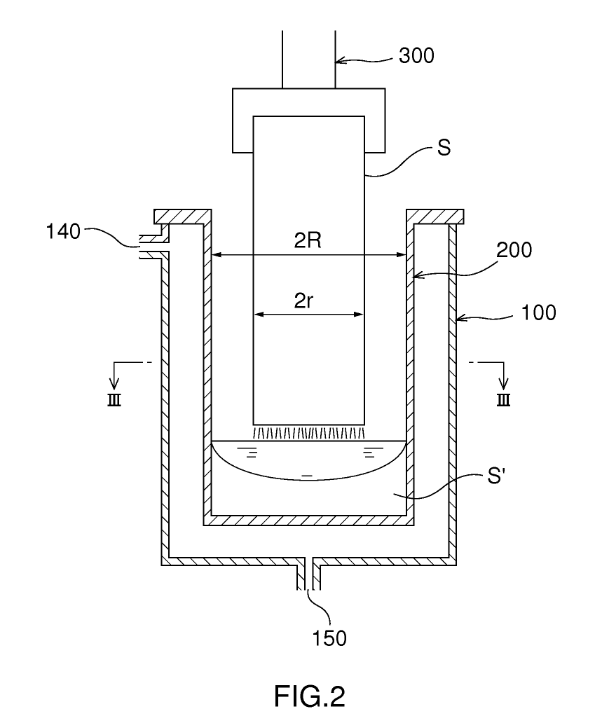

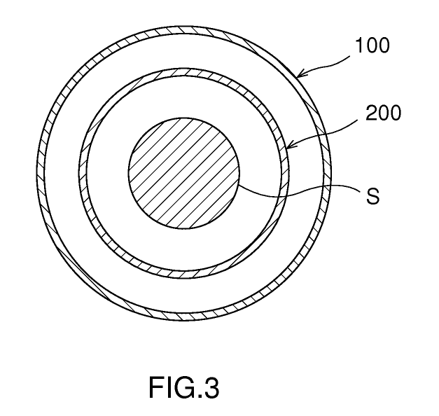

FIG. 1 is a silicon vacuum melting device (hereinafter simply referred to as “device 1”) according to an embodiment of the present invention. FIG. 2 is an enlarged view showing a principle portion of the device 1. FIG. 3 is a cross-sectional view of the device 1 taken along the line III-III in FIG. 2.

This device 1 is provided with a furnace vessel 100, a conductive water-cooled copper crucible 200 arranged in the furnace vessel 100, and a support rod 300 configured to support an upper portion of a silicon electrode (silicon mass) S.

The furnace vessel 100 is a sealed vessel arranged in such a manner that the vessel covers, e.g., the water-cooled copper crucible 200 and the silicon electrode S.

The furnace vessel 100 is provided, at its upper portion, with an exhaust port 110. At the time of melting and refining processing, the inside of the furnace vessel 100 is depressurized to a vacuum state (for example, 0.001 to 0.01 Torr) by a vacuum pump (not illustrated).

The furnace vessel 100 is provided, at its upper portion, with an insertion hole 120 through which the support rod 300 is inserted. This insertion hole 120 is preferably provided with a sealing member 130, such as, e.g., a rubber sealing member, to seal the furnace vessel 100.

At the side surface portion and bottom portion of the furnace vessel 100, cooling water ports 140 and 150 are provided, respectively. During the melting and refining processing, cooling water is introduced into the vessel 100 via the cooling water ports 140 and 150 to cool the water-cooled copper crucible 200

The water-cooled copper crucible 200 is formed into a configuration extending in a vertical direction with an opened upper end and a closed bottom end. The crucible 200 is connected to a DC power source (not illustrated) so that a positive voltage is applied.

The support rod 300 is configured to support the upper portion of the silicon electrode S so that the silicon electrode S is arranged in the water-cooled copper crucible 200 with a gap between the outer peripheral surface of the silicon electrode S and the inner peripheral surface of the water-cooled copper crucible 200.

The support rod 300 is configured to move up-and-down by the function of an electrode feeding mechanism 400, so that the silicon electrode S can be moved up-and-down in the water-cooled copper crucible 200 by the electrode feeding mechanism 400.

The support rod 300 is connected to the DC power supply (not illustrated) so that a negative voltage is applied to the silicon electrode S.

The silicon electrode S is an elongated bar-shaped silicon mass with a purity of about 99% or higher, and is vertically arranged in an suspended manner in the water-cooled copper crucible 200 with a gap between the outer peripheral surface of the silicon electrode S and the inner peripheral surface of the crucible 200. As will be explained, the silicon electrode S melts by being energized and falls in drops to be accumulated at the bottom portion of the water-cooled copper crucible 200 as molten silicon S′.

The molten silicon S′ will be solidified from its bottom portion by being cooled by the water-cooled copper crucible 200 into a solidified silicon mass while maintaining the top portion in a molten state, and therefore the molten silicon S′ has a double-layered structure including a molten layer and a solidified layer at the time of the melting and refining processing.

When a voltage is applied between the water-cooled copper crucible 200 as a positive electrode and the silicon electrode S as a negative electrode in a state in which the inside of the furnace vessel 100 is depressurized to a vacuum state, the silicon electrode S as an electrode is energized and molten. The molten silicon falls in drops to be accumulated in the bottom portion of the water-cooled copper crucible 200. The molten silicon is solidified sequentially from its bottom portion since the water-cooled copper crucible 200 is cooled. At this time, a certain amount of molten silicon is maintained in a molten state at its upper portion, and the silicon electrode S and the molten silicon S′ are kept in an electrically-connected state during the melting and refining processing by the arc discharge therebetween.

For this reason, volatile elements contained in the silicon can be refined by volatilizing them into a vapor phase. Further, since the molten silicon S′ is sequentially solidified from its bottom portion, the solidification segregation effect of impurities in the silicon can be obtained simultaneously.

By the reasons mentioned above, high-volatile impurities can be removed or eliminated from the silicon, and impurities high in segregation effect due to solidification segregation can also be removed simultaneously. In other words, it becomes technically possible to remove or eliminate all of harmful impurities contained in the silicon other than boron high in segregation coefficient such as 0.8 and high in evaporation temperature.

Further, in removing or eliminating high-volatile impurities from the silicon by the vacuum melting and simultaneously removing or eliminating segregation of impurities due to solidification of the silicon, the device structure for performing the vacuum melting and solidification can be simplified and reduced in size. In other words, the device merely requires a water-cooled copper crucible 200 for accommodating molten silicon and a spatial structure for vacuum exhaust having the same diameter as a diameter of the water-cooled copper crucible 200. Therefore, there are great advantages to productivity and economic efficiency of the device as well as an advantage to high purifying efficiency of silicon.

As for a method of melting silicon, a conventional method of melting silicon is an indirect heating method. That is, in a method of melting silicon by induction melting or a resistant heating element using a graphite crucible, a melting vessel is heated, and in an electron beam melting method, an electron gun is heated and the energy is conveyed to silicon as material to be heated. On the other hand, in a silicon melting method of the present invention, a direct heat generating method in which an electric current is passed through silicon is employed, and therefore the energy efficiency for melting silicon is high and the rate of solution is fast, which further enhances the advantage of economic efficiency.

In this embodiment, as shown in FIG. 2, as to the size of the silicon electrode S to be inserted in the water-cooled copper crucible 200, the following device structure is employed.

A gap ratio K which is defined as a ratio (π(R²−r²)/πR²) of a cross-sectional area π(R²−r²) occupied by a gap between the inner peripheral surface of the water-cooled copper crucible 200 and the outer peripheral surface of the silicon electrode S (diameter 2r) to a cross-sectional area πR² occupied by the water-cooled copper crucible 200 (diameter 2R) is set to 0.4 to 0.6.

In a conventional method of melting titanium, a device is reduced in size to increase the production volume per device, and for the purpose of preventing evaporation dissipation of alloy elements, a diameter of the melting electrode material is increased as large as possible with respect to a diameter of a water-cooled copper crucible 200 within a safety range in which no contact accident occurs. As a result, conventionally, the aforementioned gap ratio K representing the relation between the diameter of the water-cooled copper crucible 200 and the diameter of the electrode material was set to about 0.25.

The reason that the aforementioned gap ratio K is set to 0.4 to 0.6 in the present invention is as follows. One of the purposes of the vacuum melting of the silicon electrode S is to remove or eliminate volatile impurities by evaporation. The evaporation removal amount of molten dissolved materials is proportionate to an area that a gas can be freely scattered and lost from the dissolved material surface. Accordingly, to increase the evaporation amount from the silicon surface, it is required to increase the gap ratio K. However, if the gap ratio K is increased excessively, the diameter of the silicon electrode S is reduced, resulting in a reduced melting silicon amount, which in turn reduces the amount of production. For this reason, in order to effectively perform the evaporation removal of impurities and increase the amount of production, the gap ratio K is set to 0.4 to 0.6

Further, the evaporation removal effect of impurities according to the melting method of the present invention is large. That is, in general, during the process for effectively melting and evaporating impurities from a substance, it is required that the temperature of the molten material surface is high, the molten material surface is disarranged so that the molten material surface is always renewed, the molten material entirely flows so that movements of impurities in the solution is facilitated, and the degree of vacuum is high so that gaseous impurity molecules scattered from the solution into a vapor phase can be discharged.

In the melting method according to the present invention, the arc temperature reaches 3,000 to 5,000° C. and therefore the surface temperature of the molten silicon S′ is raised sufficiently. Further, the arc strongly hits against the surface of the molten silicon S, causing disarrangement of the surface, which in turn renews the surface. In addition, a DC current of 10,000 A or more passes through the molten silicon S, and therefore a pinch force (Lorentz force) due to the self-current acts on the molten silicon S′ to move and agitate the molten silicon. Furthermore, the device is discharged by a vacuum pump so that the degree of vacuum reaches 0.01 Torr and therefore the degree of vacuum is high. Thus, the impurity removal function of the present invention is large.

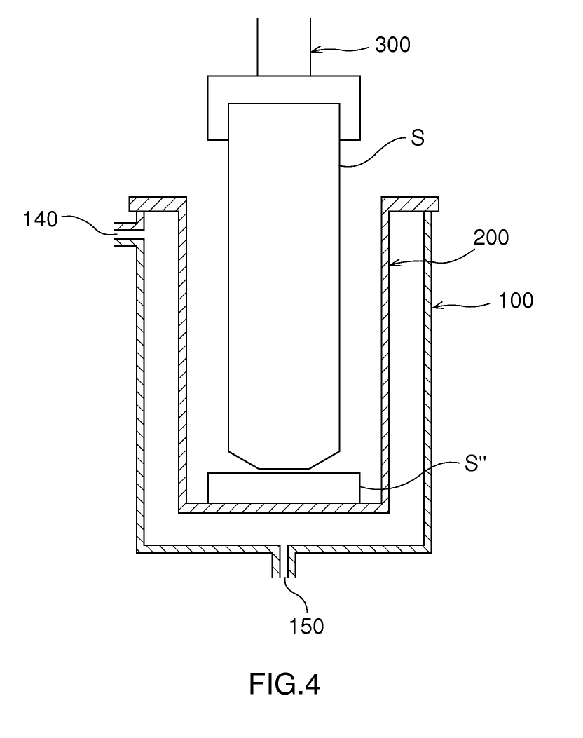

FIG. 4 is an enlarged view showing a principle portion of a device 1 according to another embodiment.

In this device 1, it is configured such that the tip end portion of the silicon electrode S is formed into an inverted cone shape or a trapezoidal shape in a side view, and the current-carrying amount of the silicon electrode S is gradually increased to raise the temperature of the silicon electrode S.

A silicon electrode S tends to cause brittle fracture by a sudden temperature raise at a temperature of about 600° C. and therefore it is required to gradually raise the temperature of the vicinity of the melting portion of the silicon electrode S prior to initiation of melting. For this reason, by forming the configuration of the tip end portion of the silicon electrode S into, for example, an inverted cone shape or a trapezoidal shape in a side view and gradually increasing the current-carrying amount to raise the temperature, possible breakage or fracture of the silicon electrode S can be prevented.

The configuration of the tip end portion of the silicon electrode S is not limited to an inverted cone shape or a trapezoidal shape in a side view, and can be, for example, any configuration in which the cross-sectional area is gradually decreased toward the tip end portion.

In preparation to initiate melting of the silicon electrode S, an initial melting silicon S″ is arranged at the bottom of the water-cooled copper crucible 200. In this case, the current-carrying of the silicon electrode S is initially performed between the silicon electrode S and the initial melting silicon S″ arranged in the water-cooled copper crucible 200, which enables smooth initiation of melting the silicon electrode S.

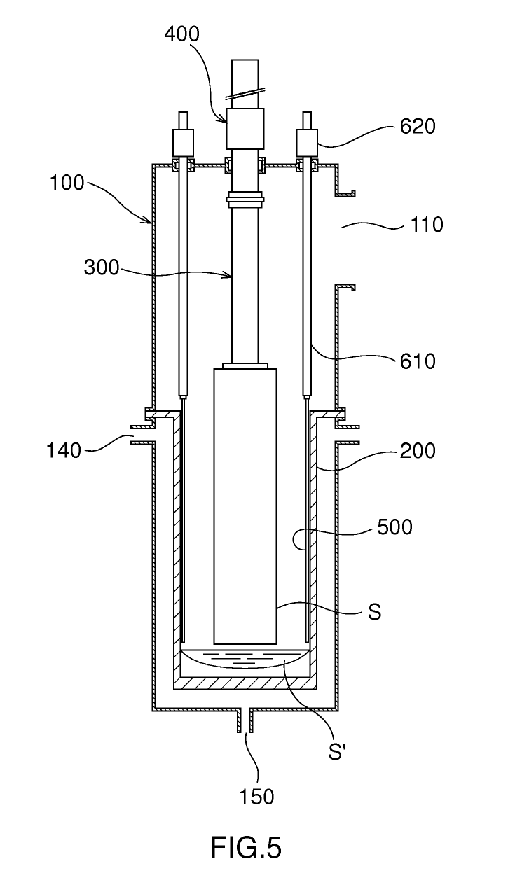

FIG. 5 shows a schematic structural view of a device 1 according to still another embodiment.

In this device 1, a vapor deposition board 500 having a configuration covering the inner wall surface of the conductive crucible 200 and movable upward is arranged in the furnace vessel 100. The configuration of the vapor deposition board 500 is not limited, and can be, for example, a cylindrical shape. Impurities to be removed or eliminated from the molten silicon S′ under a high temperature is discharged from the vessel while being reduced in pressure, but some impurities will be evaporated and remained on the inner wall of the conductive crucible 200 or the inner wall of the furnace vessel 100. However, by using the vapor deposition board 500 having a configuration covering the inner wall surface of the conductive crucible 200 and movable upward so that the vapor deposition board 500 is moved upward so as not to come into contact with the surface of the molten silicon S′ which rises according to the progress of melting of the silicon S, impurities removed by evaporation is prevented from being adhered to the inner wall of the conductive crucible 200, which prevents impurities from being re-mixed into the molten silicon S′.

### Example 1

Example 1 was performed as follows. A water-cooled copper crucible 200 having a diameter of 70 cm and a depth of 200 cm was arranged in a furnace vessel 100. A melting silicon electrode S having a diameter of 53 cm and a length of 300 cm was produced by an electromagnetic casting method (see, e.g., PCT/JP20096/71620). In this Example, the gap ratio K of the water-cooled copper crucible 200 and the silicon electrode S was set to 0.43.

Further, the silicon electrode S was produced by the electromagnetic casting so that the tip end portion of the silicon electrode S is formed into an inverted cone shape or a trapezoidal shape in a side view.

Further, in preparing for initiation of melting, an initial melting silicon S″ of about 30 Kg in weight was disposed at the bottom portion of the water-cooled copper crucible 200. The current-carrying of the silicon electrode S was initially initiated between the silicon electrode S and the initial melting silicon 5″ in the water-cooled copper crucible 200.

After arranging the silicon electrode S in the water-cooled copper crucible 200 of the furnace vessel 100, the furnace vessel 100 was sealed and then vacuum discharging was initiated. When the degree of vacuum reached 0.01 Torr or below, current-carrying to the silicon electrode S was initiated. The current-carrying amount was initially set to about 2,000 A and gradually increased. When the current-carrying amount was increased, the initial melting silicon 5″ and the silicon electrode S start melting, and when the current-carrying amount exceeded about 10,000 A, a pool of the molten silicon S′ was formed. The current was further increased to shift the operation to a steady condition. The silicon electrode S was sequentially fed downward. In the steady melting operation, a DC voltage of 25 to 26 V was applied and a current of about 16,000 A was passed. The degree of vacuum was measured immediately above the water-cooled copper crucible 200 and the melting rate was adjusted so that the degree of vacuum was held at about 0.01 Torr, and the melting operation was continued for about 6 hours.

After completion of the melting operation, the furnace vessel 100 was disassembled and a silicon mass of about 1,400 Kg in weight was taken out of the water-cooled copper crucible 200. The electric energy used for the melting operation was about 1,600 kWh per 1 ton of silicon.

The measured results of impurity concentration of the silicon mass taken out of the vessel are shown in Table 1. It was confirmed that volatile impurities and elements having a small aggregation coefficient in the silicon were removed sufficiently.

TABLE 1

| | | Impurities (ppmw) | | | | | |
|---|---|---|---|---|---|---|---|
| | | B | P | Ca | Al | Fe | C |
| Before melting | | 14 | 18 | 0.1 | 3 | 0.2 | 7 |
| After melting | Upper portion | 14 | 0.4 | <0.1 | <0.1 | <0.1 | 3 |
| | Middle portion | 13 | 0.4 | <0.1 | <0.1 | <0.1 | 3 |
| | Lower portion | 12 | 0.3 | <0.1 | <0.1 | <0.1 | 2 |

### Example 2

Example 2 was performed as follows. The size of the furnace vessel and the size of the water-cooled copper crucible 200 were the same as that in Example 1, and a water-cooled copper crucible 200 having a diameter of 70 cm and a depth of 200 cm was used. However, a melting silicon electrode S having a diameter of 45 cm and a length of 300 mm was produced by an electromagnetic casting method. In this Example, the gap ratio K of the water-cooled copper crucible 200 and the silicon electrode S was set to 0.59.

Further, the silicon electrode S was produced by the electromagnetic casting so that the tip end portion of the silicon electrode S is formed into an inverted cone shape. Further, an initial melting silicon S″ of about 30 kg in weight was disposed at the bottom portion of the water-cooled copper crucible 200 in the same manner as mentioned above.

After arranging the silicon electrode S in the water-cooled copper crucible 200 of the furnace vessel 100, the furnace vessel 100 was sealed and then vacuum discharging was initiated. When the degree of vacuum reached 0.01 Torr or below, current-carrying to the silicon electrode S was initiated and shifted to a steady operation. In the steady melting operation, a DC voltage of 25 to 26 V was applied and a current of about 14,000 A was passed. The degree of vacuum was measured immediately above the water-cooled copper crucible 200 and the melting rate was adjusted so that the degree of vacuum was held at about 0.01 Torr, and the melting operation was continued for about 5 hours.

After completion of the melting operation, the furnace vessel 100 was disassembled and a silicon mass of about 1,100 Kg in weight was taken out of the water-cooled copper crucible 200. The electric energy used for the melting operation was about 1,550 kWh per 1 ton of silicon.

The measured results of impurity concentration of the silicon mass taken out of the vessel are shown in Table 2. It was confirmed that, if the boron concentration of the initial material before being molten is set to low, volatile impurities and elements having a small aggregation coefficient in the silicon were removed efficiently and the obtained silicon can be used as silicon material for use in solar batteries.

TABLE 2

| | | Impurities (ppmw) | | | | | |
|---|---|---|---|---|---|---|---|
| | | B | P | Ca | Al | Fe | C |
| Before melting | | 0.3 | 4 | 0.1 | 5 | 0.4 | 6 |
| After melting | Upper portion | 0.3 | 0.1 | <0.1 | <0.1 | <0.1 | 3 |
| | Middle portion | 0.3 | <0.1 | <0.1 | <0.1 | <0.1 | 3 |
| | Lower portion | 0.3 | <0.1 | <0.1 | <0.1 | <0.1 | 2 |

### Example 3

Example 3 was performed as follows. The size of the furnace vessel 100 and the size of the water-cooled copper crucible 200 were the same as that in Examples 1 and 2, and a water-cooled copper crucible 200 having a diameter of 70 cm and a depth of 200 cm was used. Further, a melting silicon electrode S having a diameter of 45 cm and a length of 300 mm was produced by an electromagnetic casting method. In this Example, the gap ratio K of the water-cooled copper crucible 200 and the silicon electrode S was 0.59. The tip end portion of the silicon electrode S for initiation of melting was formed into an inverted cone shape or a trapezoidal shape in a side view as shown in FIG. 3 in the same manner as mentioned above. Further, an initial melting silicon S″ of about 30 kg in weight was disposed at the bottom portion of the water-cooled copper crucible 200 in the same manner as mentioned above.

Further, as a vapor deposition board 500 having a configuration covering the inner wall surface of the conductive crucible 200 and movable upward in the furnace vessel 100, a cylindrical member of molybdenum having an outer diameter of 67 cm, a thickness of 2 mm, and a height of 150 cm was arranged and connected to two support rods 610 movable up-and-down. The support rods 610 were configured such that the support rods 610 can be moved up-and-down by a support rode feeding mechanism 620. The inner surface of the cylindrical member of molybdenum was formed to have minute irregularities by a shot blast method so that deposited materials can be readily held under vacuum.

As for the furnace operational order, after arranging the silicon electrode S in the water-cooled copper crucible 200, the furnace vessel 100 was sealed and then vacuum discharging was initiated. When the degree of vacuum reached 0.01 Torr or below, current-carrying to the silicon electrode S was initiated and shifted to a steady operation. Simultaneously with the transition to the steady melting operation, the cylindrical vapor deposition board 500 was moved upward so that the lower end of the evaporation board 500 was away from the surface of the molten silicon S′ by about 7 cm. In the steady melting operation, a DC voltage of 25 to 26 V was applied and a current of about 14,000 A was passed. The degree of vacuum was measured immediately above the water-cooled copper crucible 200 and the melting rate was adjusted so that the degree of vacuum was held at about 0.01 Torr, and the melting operation was continued for about 5 hours.

After completion of the melting operation, the furnace vessel was disassembled and a silicon mass of about 1,100 Kg in weight was taken out of the water-cooled copper crucible 200. The electric energy used for the melting operation was about 1,550 kWh per 1 ton of silicon.

The measured results of impurity concentration of the silicon mass taken out of the vessel are shown in Table 3. It was confirmed that volatile impurities and elements having a small aggregation coefficient in the silicon were removed sufficiently and the obtained silicon can be used as silicon material for solar batteries.

TABLE 3

| | | Impurities (ppmw) | | | | | |
|---|---|---|---|---|---|---|---|
| | | B | P | Ca | Al | Fe | C |
| Before melting | | 0.2 | 8 | 0.1 | 7 | 0.7 | 7 |
| After melting | Upper portion | 0.3 | <0.1 | <0.1 | <0.1 | <0.1 | 3 |
| | Middle portion | 0.2 | <0.1 | <0.1 | <0.1 | <0.1 | 3 |
| | Lower portion | 0.2 | <0.1 | <0.1 | <0.1 | <0.1 | 2 |

### INDUSTRIAL APPLICABILITY

The present invention enables easy and economical removal of volatile impurities and impurities small in segregation coefficient in silicon and is applicable to industrialization as a method of producing silicon material for used in, e.g., solar batteries.

1. A silicon vacuum melting method comprising the steps of:
preparing a device provided with a furnace vessel, a conductive crucible arranged in the furnace vessel, and a support rod arranged to support a silicon mass;
arranging the silicon mass in the crucible using the support rod with a gap between the silicon mass and the crucible;
vacuuming the furnace vessel;
applying a voltage between the silicon mass and the conductive crucible to pass a current through the silicon mass as an electrode to thereby melt the silicon mass to obtain molten silicon; and
solidifying the molten silicon accumulated at a bottom of the conductive crucible sequentially from a bottom portion of the molten silicon by cooling the crucible while maintaining a top portion of the molten silicon in a molten state.

2. The silicon vacuum melting method as recited in claim 1,
wherein a gap ratio defined by a ratio of a cross-sectional area of a gap between the crucible and the silicon to a cross-sectional area of the crucible is set so as to fall within a range of 0.4 to 0.6.

3. The silicon vacuum melting method as recited in claim 1,
wherein the silicon mass includes a lower tip end portion facing the bottom portion of the crucible, the lower tip end portion being formed to have a cross-section area which gradually decreases toward the bottom of the crucible, and
wherein an amount of current passing through the silicon mass is gradually increased to raise a temperature of the silicon mass.

4. The silicon vacuum melting method as recited in claim 2,
wherein the silicon mass includes a tip end portion facing the bottom portion of the crucible, the tip end portion being formed to have a cross-sectional area which gradually decreased toward the bottom of the crucible, and
wherein an amount of current passing through the silicon mass is gradually increased to raise a temperature of the silicon mass.

5. The silicon vacuum melting method as recited in claim 3,
wherein the lower tip end portion of the silicon mass is formed into a trapezoidal shape in a side view.

6. The silicon vacuum melting method as recited in claim 4,
wherein the lower tip end portion of the silicon mass is formed into a trapezoidal shape in a side view.

7. The silicon vacuum melting method as recited in claim 1,
wherein a vapor deposition board movable upward and having a shape covering an inner wall surface of the conductive crucible is used.

8. The silicon vacuum melting method as recited in claim 2
wherein a vapor deposition board movable upward and having a shape covering an inner wall surface of the conductive crucible is used.

9. The silicon vacuum melting method as recited in claim 7,
wherein the vapor deposition board is moved upward so as not to come into contact with a surface of the molten silicon which rises according to a progress of melting of the silicon mass.

10. The silicon vacuum melting method as recited in claim 8,
wherein the vapor deposition board is moved upward so as not to come into contact with a surface of the molten silicon which rises according to a progress of melting of the silicon mass.

11. The silicon vacuum melting method as recited in claim 1, further comprising a step of arranging an initial melting silicon mass at the bottom of the crucible.

12. A silicon vacuum melting method comprising the steps of:
preparing a device provided with a furnace vessel, a conductive crucible arranged in the furnace vessel, a support rod arranged to support a silicon mass, and a vapor deposition member;
arranging the silicon mass in the crucible in a suspended manner using the support rod with a gap between an outer peripheral surface of the silicon mass and an inner peripheral surface of the crucible;
arranging the vapor deposition member in the conductive crucible in an upwardly movable manner;
sealing the furnace vessel;
vacuuming the furnace vessel;
connecting a direct power source to the silicon mass and the conductive crucible so that a voltage is applied between the silicon mass and the conductive crucible to cause an arc discharge between the silicon mass and the conductive crucible to thereby melt the silicon mass to obtain molten silicon;
moving the vapor deposition board upward so as not to come into contact with a surface of the molten silicon which rises according to a progress of melting of the silicon mass; and
solidifying the molten silicon accumulated at a bottom of the conductive crucible sequentially from a bottom portion of the molten silicon by cooling the crucible while maintaining a top portion of the molten silicon in a molten state.

13. The silicon vacuum melting method as recited in claim 12,
wherein the silicon mass includes a lower tip end portion formed into a trapezoidal shape in a side view.

14. The silicon vacuum melting method as recited in claim 12, further comprising a step of arranging an initial melting silicon mass at the bottom of the crucible.
